(19) United States
(12) Patent Application Publication
(10) Pub. No.: US 2007/0206731 A1
(43) Pub. Date: Sep. 6, 2007

(54) System and method for providing DSL and selected telephone service over a common line

(75) Inventors: Carol Shifrin Gruchala, Naperville, IL (US); K. Robert Stroud, Lago Vista, TX (US); Earl Mark Wallace, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/356,872

(22) Filed: Feb. 17, 2006

(51) Int. Cl. H04M 11/04

(52) U.S. Cl. 379/38

(57) ABSTRACT

The present disclosure provides a system and method for providing DSL services and selected telephone service over a common telephone line. Digits or the called numbers are received and if the called numbers correspond to an escape code, the call is enabled. A selected announcement to the calling number may be made if the call is not enabled.

### FIELD OF THE DISCLOSURE

The present invention relates in general to the field of telecommunication.

### DESCRIPTION OF THE RELATED ART

Communication service providers provision Digital Subscriber Line (DSL) services, such as access to the Internet, and traditional telephone service, commonly referred to as the Plain Old Telephone Service (POTS), to each customer over a common communication link or line, such as copper wire pair. With the advent of wireless telephone service and Voice over Internet Protocol (VoIP) telephone service, customers often wish to subscribe to the DSL service, sometimes referred to in the industry as the “Naked” DSL Service, without the traditional telephone service. The Naked DSL service can be provided over a copper wire without supplying traditional power (typically −48 volts) to the copper wire. Such a line, referred to as the “Dry Loop” DSL, can not be utilized for making emergency calls using traditional telephones. Additionally, service providers have been reluctant to offer dry loop DSL to customers due to network maintenance concerns and the expense associated with equipment needed to provide wetting current (some amount of power) to prevent the copper wires from degrading due to, for example, corrosion. Also, if an emergency call is made from a cellular telephone or via VoIP service, the location of the caller is usually not identifiable from the callers' phone number. Thus, there is a need for a system that provides customers DSL services and the ability to make selected calls, such as emergency call utilizing a common line.

### BRIEF DESCRIPTION OF THE DRAWINGS

For detailed understanding of the present disclosure, references should be made to the following detailed description of an exemplary embodiment, taken in conjunction with the accompanying drawings, wherein:

FIG. 1 shows an exemplary functional block diagram of a Service Control Point that may be utilized for placing calls according to one embodiment of the present disclosure;

FIG. 2 is a functional diagram of an exemplary system relating to processing of outgoing calls according to one embodiment of the present disclosure;

FIG. 3 illustrates a flow chart related to processing of outgoing calls according to an embodiment of the present disclosure;

FIG. 4 shows a functional system diagram related to processing of incoming calls according to an embodiment of the present disclosure;

FIG. 5 illustrates a flow chart related to a method for processing according to an embodiment of the present disclosure; and

FIG. 6 is diagrammatic representation of a machine in the form of a computer system within which a set of instructions, when executed may cause the machine to perform any one or more of the methods and processes described herein.

### DETAILED DESCRIPTION OF THE EMBODIMENTS

In view of the above, the present disclosure through one or more of its various aspects and/or embodiments is presented to provide one or more advantages, such as those noted below. The embodiments disclosed include a system, apparatus and method that enable making selected telephone calls over a telephone line that is associated with a Digital Subscriber Line (DSL) service.

In one illustrative embodiment a computer readable medium is provided that is accessible to a processor for executing instructions contained in a computer program embedded in the computer readable medium. The computer program includes instructions to detect or monitor a trigger on a telephone line linked to a Digital Subscriber Line service, instructions to determine or collect digits or numbers for a call associated with the telephone line and instructions to enable the call to proceed if the collected digits meet a selected criterion.

In one aspect, the selected criterion may be an escape code or a telephone number or identifier that may include one or more escape codes that may include one or more emergency services access numbers, such as “911,” a government service access number, etc. In one aspect, the escape codes may be stored in a data base accessible to the processor. In another aspect, the computer program may include instructions to affect a trigger upon receiving the call. In one aspect, the trigger may be an off-hook delay trigger or a termination attempt trigger. In another aspect, the computer program may include instructions to receive a command or instruction to send an announcement in response to the collected digits and instructions to send the announcement to the calling telephone number in response to the off-hook delay or the termination trigger attempt. The computer program also may include instructions to query a Service Control Point (SCP) when the collected digits do not meet the selected criterion. The computer program may include instructions to process instructions received from the SCP that may include sending the announcement over the telephone line. In another aspect, the computer program may include instructions to receive an input for routing a call associated with the collected digits to a selected location.

In another aspect, a system for delivering a Digital Subscriber Line (DSL) service to customer premises is provided wherein a telephone line is used or linked to provide the DSL service. The system includes a database that stores one or more escape codes associated with a telephone service, a processor that utilizes a computer program to determine if a call associated with the line corresponds to one of the escape codes or numbers and allows the call to proceed if the call corresponds to one of the escape codes.

In another aspect, a method for processing a telephone call associated with a telephone line linked to a Digital Subscriber Line is provided. The method includes monitoring a trigger associated with the telephone line, collecting digits for a telephone call associated with the telephone line and enabling the call to proceed if the collected digits meet a selected criterion.

In one aspect the selected criterion is that telephone call is associated with an escape code. In still another aspect the monitoring corresponds to a trigger that may be an off-hook delay trigger or a termination attempt trigger. A suitable announcement may be made in response to the trigger. Also, the call may be routed to a selected location.

For ease of explanation and understanding of the present disclosure, it is considered helpful to provide a brief explanation of certain aspects relating to a DSL service and telephone service (also referred to as plain old telephone service or POTS). Many service providers typically provide DSL services over a line along with traditional POTS telephone service. Customers are increasingly asking for “Naked” DSL or Dry Loop DSL where DSL is provided by the service provider and the traditional telephone service (POTS service) is not requested. Often, these customers rely on VoIP or cellular service for voice communications needs. Dry Loop DSL presents a problem when there is copper wire without a current (e.g. active phone line).

If a mechanical switch contact associated with the dry loop is operated with too little current, the contacts will tend to accumulate excessive resistance and may fail prematurely. This minimum amount of electric current necessary to keep a mechanical switch contact in good health is referred to as the wetting current. Wetting current, also known as loop sealing current, is a low-level DC current (usually less than 20 mA) applied to a loop for the specific purpose of maintaining cable splice integrity by preventing the build-up of oxidation. The wetting current is primarily used in all-digital services on dry loops, unlike services with underlying POTS (ADSL for example) that inherently provide wetting current by means of off-hook loop current. Wetting current is defined in the Bellcore and CCITT Layer 1 specifications. This is typically a low current (1-20 mA) DC signal applied to the copper pair to reduce oxidation at line splices, to provide a troubleshooting aid in the field and as indications of connected lines. True Dry loop DSL needs a current source at a service provider Central Office (CO) to take the place of −48 vdc battery voltage used with traditional POTS service along with a current sink at the CPE to have a DC path (normally a telephone is the current sink). Central Office equipment vendors provide this current source in the form of CO equipment. There are supplemental devices that a service provider can add to their system that provides wetting current. This device requires a current terminator or resistor at the ADSL end user's premises.

In a typical system, the ADSL modem looks like an open DC circuit to the CO. Used in conjunction with a CO sourced wetting current, there are supplemental devices that provide wetting/sealing current terminators so that the circuit can be completed using appropriate electrical specifications, thus providing the resistance necessary to retard corrosion. In aspects disclosed herein, these third party wetting current devices may not be needed in order for Dry Loop DSL to be network compliant.

One illustrative embodiment of the present disclosure provides a POTS-like line associated with the DSL, wherein the line is configured as to not allow any incoming or outgoing calls with the exception of selected escape calls, such as 911 calls. Providing the POTS-like line can eliminate the need to install “manufactured” wetting current equipment and supplementary devices or equipment. In one aspect, a DSL modem is provided to a customer premises equipment (CPE) with a current terminator included. The line from a CO to CPE is provisioned with a traditional POTS circuit along with ADSL. The CO POTS battery supplies the current that is required for the line to make escape calls.

In one embodiment of the present disclosure, an Advanced Intelligent Network (AIN) service that may be associated with the line to effectively block all calls (incoming and outgoing) with the exception of escape calls or any other predetermined numbers. An AIN service may provide enhanced voice, video and data services and dynamic routing capabilities by using two or more different networks. The actual voice call may be transmitted over a circuit-switched network, and the signaling may be done on a separate packet-switched network such as Signaling System Seven (SS7).

In one aspect, an Advanced Intelligent Network provides a method of distributing call processing intelligence across multiple network elements. AIN services may be centrally located (e.g., at a CO) or several aspects of an AIN service package may be distributed over a network and with aspects that reside concurrently at a CO, at different locations on one or more service provider networks, and even on CPEs. As noted earlier, AIN service works in conjunction with SS7 technology. SS7 is a standard protocol which supports Common Channel Signaling. Common Channel Signaling (CCS) is out-of-band signaling that provides separate channels for control messages. AIN uses SS7 for carrying messages between the network elements. AIN and SS7 networks are known in the art and include: Service Switching Points (SSPs); Service Control Points (SCPs); Signaling Transfer Points (STPs); Intelligent Peripherals (IPs); and Service Management System (SMS).

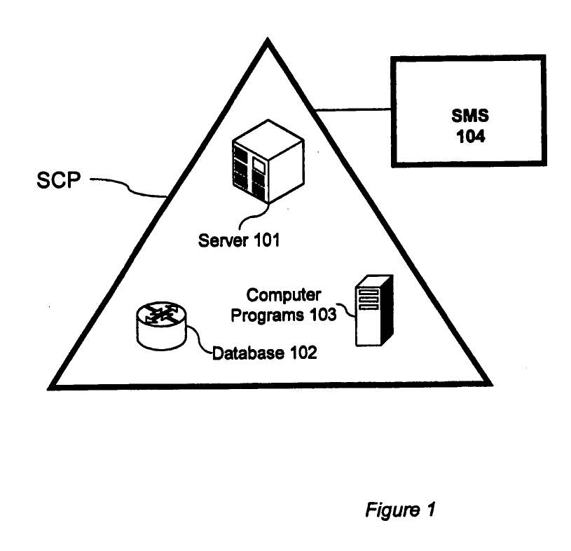

In one aspect of the present disclosure, the Service Control Point (SCP) is a component of an Advanced Intelligent Network that stores customer data, contains service logic, and responds to queries from SSPs. As illustrated in FIG. 1, the SCP may include a server 101, database 102 and associated computer programs 103 or their equivalents. The SCP is shown linked to a service management system (SMS) 104. The SCP includes a database of customers and network information or the SCP may obtain further information from SMS 104. The SCP has information for routing or blocking calls, processing call logistics and delivering instructions to Network locations to enable performance of any of the programs and methods described herein.

A Service Switching Point (SSP) is a switching system equipped with Advanced Intelligent Network Software and SS7 connectivity that allows it to communicate with the Service Control Point (SCP). The Signal Transfer Points (STPs) are nodes within the CCS signaling network that route messages from one link to another. The Intelligent Peripheral (IP) is a network component that provides resources such as customized voice announcements, voice recognition and digit collection. It is operatively coupled to one or more SSPs. A Service Management System (SMS) is an administration system used to provision services in the SCP including adding, changing or deleting customer subscriptions/data. It also provides end-user control of services through customized screens, reports or interactive voice response. Signaling System Seven Links are data paths that connect the SCP to the STP and the STP to the SSP.

Telephone numbers connected to an SSP can be programmed in the switch to encounter AIN functionality through assignment of AIN triggers. Triggering is the process of identifying AIN calls. A trigger provides an indication to the switch that it may need to suspend normal call processing and send a query message to the SCP. There are several types of triggers, including triggers referred to as subscribed, group-based, and office-based triggers.

Subscribed triggers are software features that are assigned in the SSP to a customer's line. Group-based triggers are software features that are assigned in the SSP to software-defined groups of users, (i.e. Centrex Groups). Office-based triggers are software features assigned to the entire SSP. Triggers that are encountered on outbound calls are called originating triggers. A common originating trigger is the off-hook delay trigger. The SSP collects the dialed digits and sends a query message to the SCP. The message contains the digits dialed, the trigger encountered and the calling party number. The service logic determines how to route the call by analyzing the query message. Triggers that are encountered on incoming calls are called “terminating triggers”. A common terminating trigger is called the Termination Attempt Trigger (TAT). Before a call reaches the subscriber, the TAT sends a query message to the SCP for instructions on how to route the call.

Also, events may be associated with trigger processing. For example, when a competitive local exchange carrier (CLEC) end user, served via an unbundled switch port, places a call, an originating trigger may cause a query to the SCP to initiate billing for Shared Transport.

Service Logic can be created for an SCP, based on service requirements, to utilize information such as the trigger that was encountered as well as calling number, called number, time of day, and redirecting information. Based on the service needs, the SCP logic can route the call to intercept, can collect and analyze digits entered, can forward the call to other numbers, can return display name and provide other capabilities.

In one aspect of the disclosure, the AIN service provides both monitoring of an Off Hook Delay (OHD) trigger and Termination Attempt Trigger (TAT) to capture outgoing and incoming calls, respectively. Other aspects include separate software implementations to monitor and respond to an OHD trigger or to monitor and respond to TATs.

In one aspect, the Off-Hook Delay (OHD) trigger is a trigger that is recognized upon detection of a call attempt from an originating facility which has an assigned trigger. An OHD trigger may be detected when the caller goes off-hook; however, a query may be delayed until digit collection is completed. In one aspect, the AIN service suspends call processing and launches a query to an SCP for further instructions. The SCP can instruct the service to perform various functions, such as block the call, route the call to a specified number, play an announcement, play an announcement while collecting digits, or play an announcement after a trigger or in response to a trigger. In one embodiment certain dialing codes (such as 911) are exempted from call blocking when an OHD trigger is assigned to an origination at the customer CPE. These dialed patterns, which may include a plurality of different emergency numbers, may be referred to as escape codes and are specified by the service provider and/or software associated with customer or network equipment. If the dialed digits match an escape code, an OHD trigger may be ignored or bypassed, and call processing will proceed without suspension, or the call may be routed according to the logic associated with the escape code.

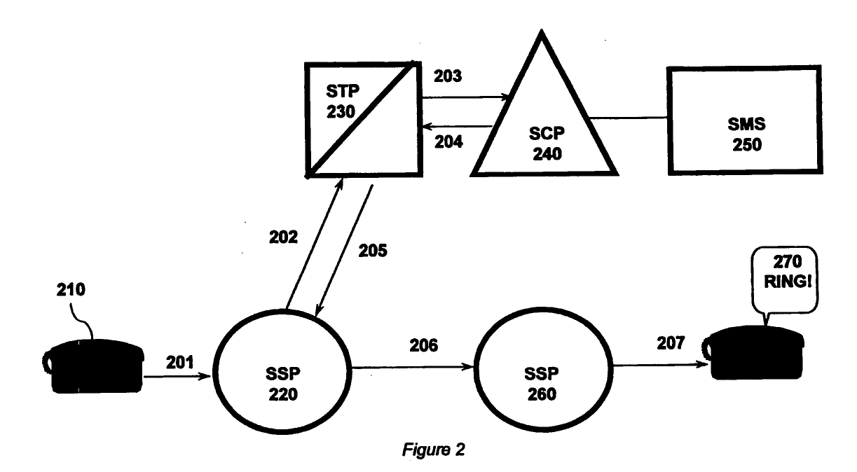

FIG. 2 illustrates an exemplary response to an originating trigger with related call processing. When an originating call is received along a network path 201 at SSP 220, which is the origination SSP, digits (i.e. the calling party's phone numbers) from the originating phone are collected and analyzed. If the digits correspond to an escape code (e.g., an emergency services request) the call proceeds to its destination 270 having “escaped” AIN processing due to the escape code. If the digits do not correspond to an escape code, call processing is suspended until the SSP 220 receives additional information from SCP 240. A request from switch 220 proceeds to an STP 230 as shown by line 202 and then to SCP 240 as shown by line 203. Instructions for call processing are returned from SCP 240 to switch 220 via STP 230 as shown by lines 203 and 205 respectively. If the call meets the requirements for being allowed to proceed, the call is forwarded on to other switches, e.g., SSP 260, and on to a destination connection 270 as shown by lines 206 and 207.

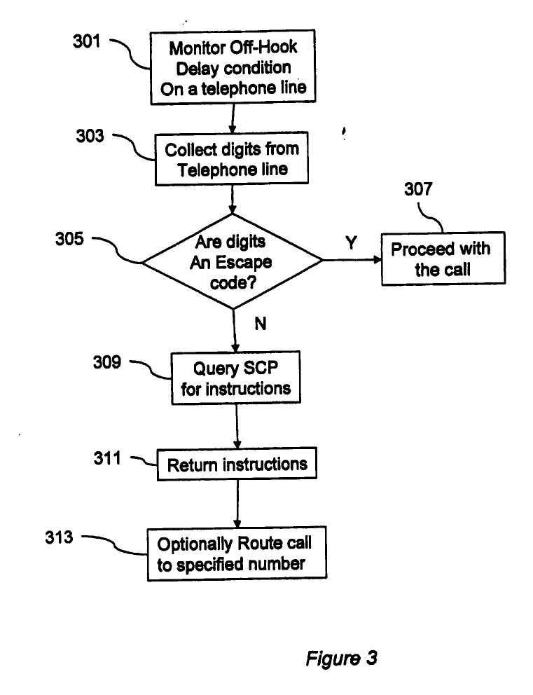

FIG. 3 illustrates a flow chart that shows an aspect that includes monitoring an off-hook delay trigger or condition 301 on a telephone line, for example when a caller picks up a receiver and wants to make an outgoing call. At this point, a query may optionally be sent from the telephone over the network to a SCP. Digits entered into the telephone during the off-hook condition from the telephone are received and collected 303. A suitable announcement may be provided to the caller during digit collection. The digits collected are analyzed, for example by SSP, to determine if the digits are an escape code 305. If the digits correspond to an escape code, the call proceeds to the called numbers, as shown at block 307. If the digits do not correspond to an escape code the outgoing call may be suspended or blocked, and a query sent to an SCP for instructions 309. At this point an announcement may be provided to the originating phone. Instructions to the SSP to respond to the originating call may be returned from the SCP 311. Also, if the call is not blocked, the call may be routed to a specified number based on instructions from the SCP 313. The specified number may be selected according to instructions associated with the SCP, and the selection may further be based on the digits collected from the telephone line.

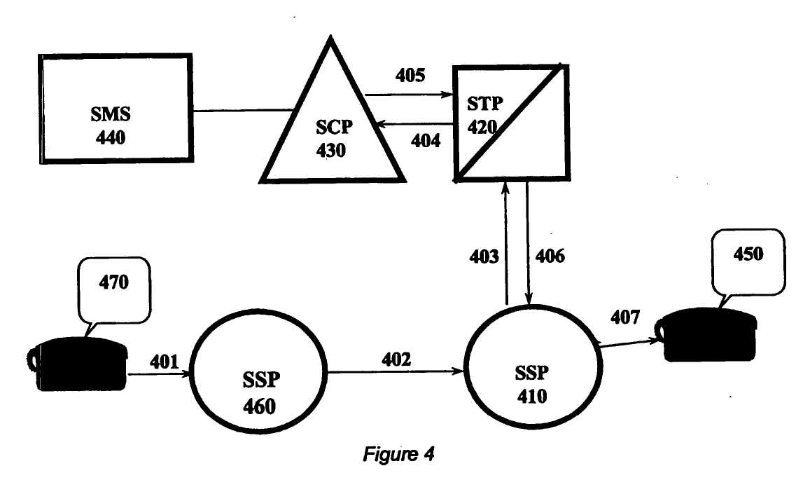

The Termination Attempt Trigger (TAT) may be provided to terminate an incoming call. As illustrated in FIG. 4, a TAT may be detected at a terminating SSP 410 when it has been determined that an originating CPE 470 is placing a call directed to CPE 450 (e.g., the dialed number according to one aspect) to which a TAT is provisioned. When the incoming call is detected, call processing is suspended and a query is sent to SCP 430 for further processing instructions. After instructions are returned to switch 410 the call may then be routed via the SCP instructions or simply terminated. The SCP may provide instructions or an announcement ID request back to the origination SSP 460. In one aspect, a TAT is provisioned by a service provider against the number of the telephone service (or the CPE).

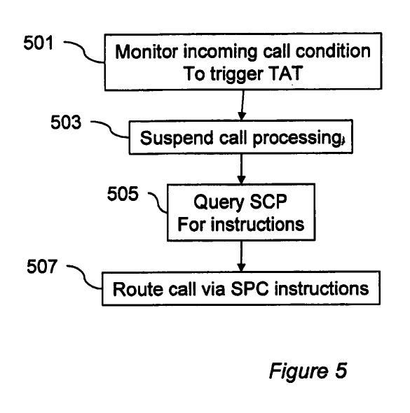

FIG. 5 illustrates an aspect that includes monitoring a termination attempt trigger condition 501 on a telephone line linked to a DSL service, for example when an incoming call is detected being routed to the telephone. The call processing is suspended 503 and a query is sent to an SCP for instructions 505. The call is then routed based on the instructions from the SCP 507, which instructions may be determined by AIN service logic.

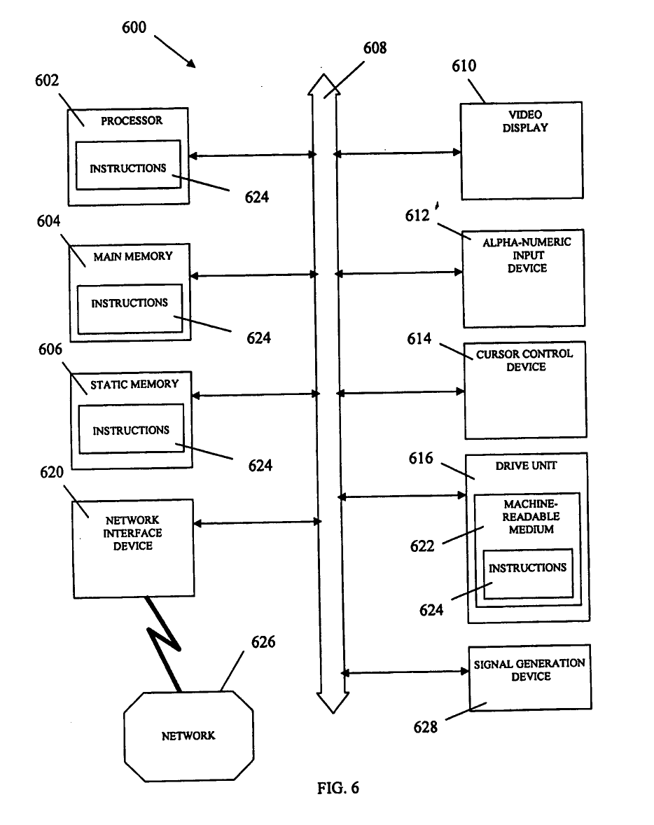

The methods described herein maybe implemented by any suitable computer system that includes or has access to programs that includes instructions corresponding to the various steps and aspects described herein. FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network, for example including and not limited to IP Network 330 which may also be linked with a service provider's telephone network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, modem, a modem for xDSL, or any machine capable of executing a set of instructions (sequential or otherwise) that specify actions to be taken by that machine. It will be understood that a device of the illustrative includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal displays (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 650.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present illustrative embodiment, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

What is claimed is:

1. A computer readable medium accessible to a processor for executing instructions contained in a computer program embedded in the computer readable medium, the computer program comprising:
instructions to monitor a trigger associated with a telephone line linked to a Digital Subscriber Line (DSL) service;
instructions to determine digits for a call associated with the telephone line; and
instructions to enable the call to proceed if the determined digits meet a selected criterion.

2. The computer readable medium of claim 1, wherein the selected criterion is an escape code that is one of i) an emergency services access number, ii) a government services access number, and iii) a help line number.

3. The computer readable medium of claim 1, wherein the trigger is one of i) an off-hook delay trigger, and ii) a termination attempt trigger.

4. The computer readable medium of claim 1, wherein the computer program further comprises instructions to send an announcement over the telephone line in response to one of: an off-hook delay trigger; and a termination trigger attempt.

5. The computer readable medium of claim 1, wherein the computer program further comprises instructions to query a Service Control Point (SCP) when the determined digits do not meet the selected criterion.

6. The computer readable medium of claim 5, wherein the computer program further comprises instructions to process a response received from the SCP.

7. The computer readable medium of claim 1, wherein the computer program further comprises instructions to receive an input for routing a call associated with the determined digits to a selected location.

8. A system for delivering a Digital Subscriber Line (DSL) service to customer premises comprising:
a telephone line linked to the DSL service;
a database that stores an escape code;
a service switching point (SSP) linked to the database for monitoring presence of the escape code in response to a detected trigger; and
a server having access to a computer program, the server utilizing the computer program to complete a telephone call associated with the telephone line if the telephone call corresponds to the escape code.

9. The system of claim 8, wherein the telephone service is a Plain Old Telephone Service (POTS) from a Central Office to a Customer Premises location.

10. The system of claim 8 further comprising a DSL modem coupled to an end of the telephone line with a current terminator.

11. The system of claim 8, wherein the computer program includes instructions to provide an announcement to a calling party initiating the telephone call.

12. The system of claim 8, wherein the escape code is associated with one of the group consisting of: i) emergency services; ii) a customer help; iii) a government services.

13. The system of claim 8, wherein the trigger is one of: i) an off-hook delay trigger and ii) a termination attempt trigger.

14. The system of claim 8, wherein the computer program further comprises an AIN service logic instruction.

15. The system of claim 8, wherein the server routes the call to a selected location based on instructions from a Service Control Point.

16. A method for processing a telephone call over telephone linked to a Digital Subscriber Line service, comprising:
monitoring a trigger associated with the telephone line;
determining digits for a telephone call associated with the telephone service; and
enabling the call to proceed if the determined digits meet a selected criterion.

17. The method of claim 16, wherein the selected criterion is an escape code that is one of i) an emergency services access number, ii) a government services access number, and iii) a help line number.

18. The method of claim 16, wherein the trigger is one of i) an off-hook delay trigger, and ii) a termination attempt trigger.

19. The method of claim 16 further comprising sending an announcement to a party making the call in response to one of: an off-hook delay trigger, and a termination attempt trigger.

20. The method of claim 16 further comprising routing the call to a selected location if the determined digits do not meet the selected criterion.

21. The method of claim 16 further comprising sending a query to obtain instruction for an action if the determined digits do not meet the selected criterion; and taking the action.
